(19) United States
(12) Patent Application Publication
(10) Pub. No.: US 2021/0357982 A1
(43) Pub. Date: Nov. 18, 2021

(54) DYNAMIC DISPLAY NETWORK FOR TRACKING DISPLAY OPPORTUNITIES

(71) Applicant: Matthew JAY, Basalt, CO (US)

(72) Inventor: Matthew JAY, Basalt, CO (US)

(21) Appl. No.: 17/387,585

(22) Filed: Jul. 28, 2021

Related U.S. Application Data
(63) Continuation-in-part of application No. 16/304,667, filed on Nov. 26, 2018, now abandoned.
(60) Provisional application No. 62/341,932, filed on May 26, 2016.

(51) Int. Cl. G06Q 30/02; H04W 4/80; G06Q 50/30

(52) U.S. Cl. CPC G06Q 30/0266; G06Q 50/30; H04W 4/80; G06Q 30/0261

(57) ABSTRACT

Taxis and other vehicles are used to transport passengers between locations. Particularly in the case of the ride sharing network, the scheduling server is aware of the start (pick-up) and end (drop-off) locations for each route a passenger has requested. Based upon one or both of the start and end locations, a dynamic display network may determine a target opportunity for displayed content. The dynamic display network may automatically match display content requirements to display opportunities and determine an operational area for a particular vehicle based upon planned or actual movement information received from the mobile network. The display content may be sent to a mobile device of a driver then shared with a non-networked display device of the vehicle. It may also include visual displays, sample products, brochures, in electronic or hard copy format and other display content relevant to target opportunities and/or operational areas.

### CROSS REFERENCE TO RELATED APPLICATIONS

The present application is a continuation-in-part of U.S. application Ser. No. 16/304,667, filed Nov. 26, 2018, which claims the benefit of priority from U.S. Provisional Application Ser. No. 62/341,932, filed May 26, 2016, both of which are incorporated herein by reference in their entirety.

### BACKGROUND

Services exist for coordinating movement of vehicles, such as for taxis and/or private vehicles when operating as part of a ride sharing network (e.g. Uber or Lyft). Typically, drivers and passengers in the ride sharing network use mobile devices to connect to the service over a communication network, such as a cellular network. As such, the ride sharing network is aware of the current location of vehicles and their intended routes as they pick-up and transport passengers. These vehicles move dynamically based upon the coordination of the network and in turn provide the network with their locations. Different vehicles operate in different areas, and may change their area of operation based upon the requested routes.

Vehicles, such as taxis, buses and ride sharing vehicles are popular with advertisers because an advertising message receives a high degree of visibility through the movement of the vehicle, as well it's use by many different people. Typically, advertisements are static, such as designs added to the side of busses or a car-top display on a taxi. Displays may also be provided on the interior of a vehicle, but even if they are digital, the displays updated infrequently and still function as a static display instead of being customizable to individual passengers or locations. Adding a networking capability to digital displays in moving vehicles requires an expensive cellular data plan and possibly replacement of the digital display.

### SUMMARY OF THE INVENTION

Taxis and other vehicles are used to transport passengers between locations. Particularly in the case of the ride sharing network, the scheduling server is aware of the start (pick-up) and end (drop-off) locations for each route a passenger has requested. Based upon one or both of the start and end locations, a dynamic display network may determine a target opportunity for displayed content such as advertisements on a non-networked display inside or outside the vehicle. For example, where an end location of a passenger is proximate a theater, and the drop off time is estimated at six-thirty-PM, the dynamic display network may determine that the passenger is interested in theater, and is therefore a target opportunity for content related to the theater. In another example, when the start location is proximate a baseball stadium and the estimated pick-up time is six-PM, the dynamic display network may assume that the passenger is returning from attending a game at the stadium, and thereby determine that the passenger provides a target opportunity for content related to baseball.

The dynamic display network automatically matches display content requirements to display opportunities. In one example, prior to picking up a passenger, the driver of a vehicle is instructed to place the matched display content such that it will be seen by the passenger. Where the vehicle includes an electronic display screen, the dynamic display network may automatically select and display targeted content based upon the determined target opportunity.

The dynamic display network may communicate with a mobile device of the driver of the vehicle to determine movement data and send appropriate display content. The mobile device of the driver may be connected to the non-networked display using s short-range communication technology.

In another embodiment, the dynamic display network may automatically determine an operational area for a particular vehicle based upon planned or actual movement information received from the mobile network. The dynamic display network automatically provides display content to the vehicle based upon the determined operational area. For example, where movement data for the vehicle indicates that it will operate within the city center of Denver, Colo., the dynamic display network automatically selects and delivers display content associated with the Denver area.

The display content may include visual displays, sample products, brochures, in electronic or hard copy format and other display content relevant to target opportunities and/or operational areas.

### BRIEF DESCRIPTION OF THE FIGURES

FIG. 1 shows one example dynamic display network for tracking dynamic display opportunities, in an embodiment.

FIG. 2 shows example detail of the movement data of FIG. 1, in an embodiment.

FIG. 3 shows the dynamic display server of FIG. 1 in further example detail.

FIG. 4 shows example detail of the opportunity rules of FIG. 3, in an embodiment.

FIG. 5 shows example data of the opportunity rules of FIGS. 3 and 4, in an embodiment.

FIG. 6 is a flowchart illustrating one example method for dynamically tracking display content placements, in an embodiment.

FIG. 7 is a flowchart illustrating one example method for dynamically placing display content, in an embodiment.

### DETAILED DESCRIPTION OF THE EMBODIMENTS

Vehicles used in taxi fleets and/or ride sharing schemes may include static digital displays that display advertising content to passengers or viewers outside the vehicle. However, these displays do not adapt to the vehicle location or viewer. Typically, digital displays may be updated infrequently and still function as a static display instead of being customizable to individual passengers or locations.

Taking Las Vegas as an example, a taxi may display content corresponding to various casinos or restaurants located along the Las Vegas strip. However, many riders take such taxis from the Las Vegas strip to downtown Las Vegas which makes the displayed content less relevant for the actual viewers. Moreover, the displays of these vehicles are often internal, displaying content only to the rider. These internal displays are not dynamic and are typically preloaded with content that is not capable of dynamically appealing to the rider (who in this case is the display viewer). The present disclosure provides a dynamic display that adapts to the viewer (intended target) based upon knowledge of what the viewer is located near, where the viewer is heading to, and/or where the viewer is heading from. As such, embodiments disclosed herein, via capitalizing and rooting itself in ability to connect virtually to any network, is capable of providing on-the-fly targeted display content to an identified target. However, adding a networking capability to digital displays in moving vehicles requires an expensive cellular data plan. In embodiments, a non-networked display in a vehicle can be updated dynamically through a connection to the mobile device of a driver of the vehicle using a short-range communication technology.

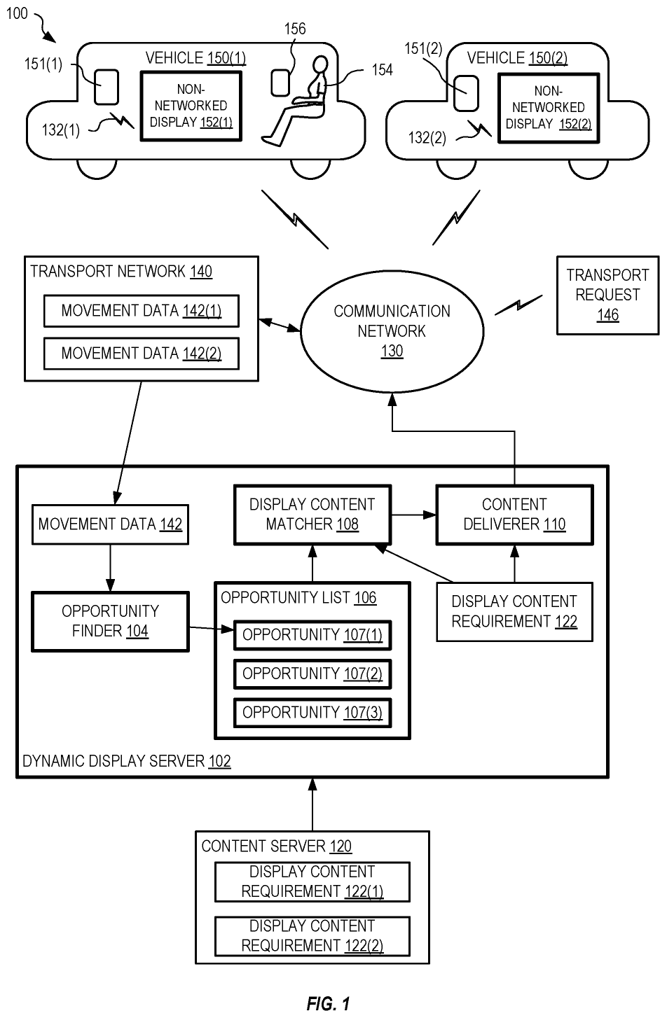

FIG. 1 shows one example dynamic display network 100 for tracking dynamic display opportunities. Network 100 includes a plurality of vehicles 150. Each vehicle is driven by driver using a mobile device 151 that is wirelessly connected to communication network 130, for example, a cellular network. Passenger devices 156 are also connected to communication network 130. Driver mobile devices 151 are connected to non-networked displays 152 using a short-range wireless communication technology 132 such as Bluetooth®. In embodiments, mobile devices 151 may be connected to non-networked displays 152 using a wired cable.

A dynamic display server 102 that is one or more computers with memory, a processor, and software implementing an opportunity finder 104, an opportunity list 106, a display content matcher 108, and a content deliverer 110. Dynamic display server 102 receives display content requirements 122 from a content server 120 and receives movement data 142 from a transport network 140. Display content requirements 122 may include advertising content as well as a location and time for displaying the content, for example.

Transport network 140 may represent a taxi or ride sharing network (e.g., Uber or Lyft). In operation, transport network 140 receives a transport request 146 from a passenger 154 using a passenger device 156 to carry the passenger 154 from a start location and to an end location. Based upon transport request 146 and a current location and availability of at least one vehicle 150, transport network 140 sends transport request 146 to a mobile device 151 associated with that vehicle. Mobile device 151 is for example a smartphone running an app (e.g., a ride sharing app such as Uber, Lyft, or any other ride sharing service). When the driver of vehicle 150 accepts transport request 146 (e.g., using mobile device 151), transport network 140 generates movement data 142 based upon transport request 146 and corresponding to vehicle 150, and sends that movement data to dynamic display server 102. Mobile device 151 may provide other tracking information (e.g., current location, and so on) of vehicle 150 to transport network 140 over communication network 130. Each vehicle 150 provides a non-networked display 152 that was previously poorly, or not utilized because the display content was static and not capable of on-the-fly adaptation to any of the location, surroundings, and rider of the vehicle.

Mobile device 151 and transport network 140 cooperate to maintain detailed movement data 142 for each vehicle 150. In embodiments, the location of non-networked display 152 may also be obtained from other tracking devices such as a Global Positioning Satellite (GPS) system in or on the vehicle 150. By using this detailed movement information, dynamic display server 102 operates to deliver more targeted display content to each non-networked display 152.

Dynamic display server 102 receives movement data 142 from transport network 140. Opportunity finder 104 processes movement data 142 and identifies display opportunities 107 based upon information within movement data 142 and stores these display opportunities 107 within an opportunity list 106. Since movement data 142 is continually updated by transport network 140 based upon movement of vehicles 150, display opportunities 107 within opportunity list 106 are also dynamic in nature. That is, display opportunities 107 are updated automatically based on the movement of vehicles 150, as well as expected future location(s) of vehicles 150.

Display content matcher 108 may comprise associated software that, when executed by a processor, operates to match received display content requirements 122 with one or more display opportunities 107 within display opportunity list 106. Content deliverer 110 sends associated display content of the display content requirement 122 to the corresponding vehicle 150 based upon the matched display opportunity 107. In embodiments, content deliverer 110 sends the associated display content, or instructions associated therewith, over communication network 130 to mobile device 151. In one embodiment, content deliverer 110 sends display content of display content requirement 122 directly (e.g., via mobile device 151) to vehicle 150. In another embodiment, content deliverer 110 sends instructions for displaying content of display content requirement 122 (e.g., via mobile device 151) to vehicle 150 over communication network 130.

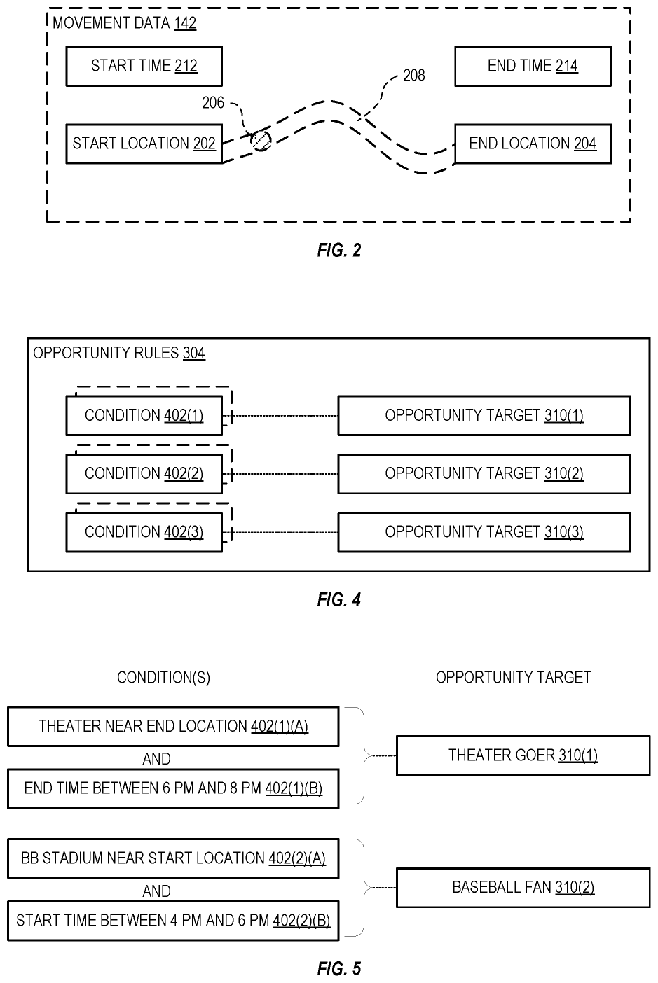

FIG. 2 shows example detail of movement data 142 of FIG. 1. Movement data 142 includes a start location 202, a start time 212, an end location 204, an end time 214, a current location 206 and optionally a route 208. Such detailed movement information is typically not available in other transport networks, however, when transport network 140 is a ride sharing network, transport requests are more detailed as they are provided directly to the network by the passenger 154 using an app running on a smartphone, or via the driver when a transport is accepted by the driver.

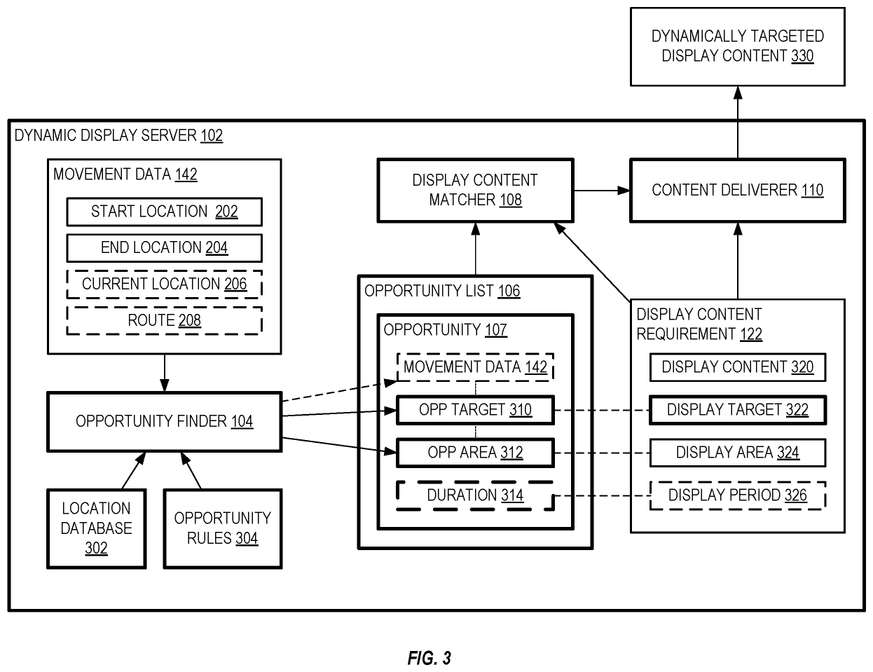

FIG. 3 shows dynamic display server 102 of FIG. 1 in further example detail. FIG. 4 shows example detail of opportunity rules 304 of FIG. 3. FIG. 5 shows example data of opportunity rules 304 of FIGS. 3 and 4. FIGS. 3, 4 and 5 are best viewed together with the following description.

Opportunity finder 104 processes movement data 142 received from transport network 140 to identify and define display opportunity 107. Based upon one or more of start location 202 and end location 204, opportunity finder 104 may determine an opportunity target 310. Opportunity finder 104 may utilize a location database 302 that defines the location of various landmarks and opportunity rules 304 that define how opportunity targets 310 are identified. In one embodiment, location database 302 is external to dynamic display server 102, such as when provided by a third party and accessible via the Internet for example. For each identified display opportunity 107, opportunity finder 104 may also identify one or more opportunity targets 310, where each opportunity target 310 is identified based upon one or more conditions 402. As shown in FIG. 4, condition 402(1) is used to identify opportunity target 310(1), condition 402(2) is used to identify opportunity target 310(2), and condition 402(3) is used to identify opportunity target 310(3).

In one embodiment, content deliverer 110 sends dynamically targeted display content 330 to a mobile device 156 of passenger 154. For example, where end location 204 for passenger 154 is at an airport and display content matcher 108 matches display content requirement 122 provided by an airport restaurant, content deliverer 110 may be instructed to send content to a mobile device 156 of passenger 154 after end location 204 has been reached. That is, dynamically targeted display content 330 is delivered to mobile device 156 of passenger 154 after passenger 154 has left vehicle 150 via communication network 130. For example, where end location 204 is proximate a restaurant, content 330 may represent a coupon for that restaurant. In another example, where end location 204 is near a movie theater, content 330 may be a trailer for a movie playing at that theater. In another embodiment, as passenger 154 is being dropped off at end location 204 that is near a gym, the driver of vehicle 150 may be instructed to provide an energy bar sample to passenger 154. Thus, system 100 provides dynamically targeted display (and sample) opportunities that allow content to be delivered to a more receptive audience.

FIG. 5 shows example data of opportunity rules 304 of FIGS. 3 and 4, where opportunity target 310(1) is a theater goer, and opportunity target 310(2) is a baseball fan. Opportunity target 310(1) is identified when two conditions 402(1)(A) and 402(1)(B) are true. Condition 402(1)(A) requires that a theater is located near end location 204 and condition 402(1)(B) requires that end time 214 (i.e., the estimated time of arrival at end location 204) is between six PM and eight PM. That is, a passenger 154 being transported by vehicle 150 that is being dropped off near a theater at a time before the start of a show is identified as a theater goer. Opportunity target 310(2) is identified when two conditions 402(2)(A) and 402(2)(B) are true. Condition 402(2)(A) requires that a baseball stadium is located near a start location and condition 402(2)(B) requires that start time 212 (i.e., the time the passenger 154 has requested to be picked up from start location 202) is between four PM and six PM. That is, a passenger 154 being transported by vehicle 150 that is being picked up near the baseball stadium at a time after the game has ended is identified as a baseball fan. Determination of opportunity targets 310 may be made using more or fewer conditions than discussed above. In one embodiment, display content server 120 may define display content requirement 122 to send dynamically targeted display content 330 to mobile device 156 of passenger 154 prior to pick-up of passenger 154 by vehicle 150. For example, where start location 202 is near one or more bars, dynamically targeted display content 330 may be a coupon for a particular liquor or beverage that is delivered to passenger 154 while they are still in the bar.

As appreciated by one of ordinary skill in the art, opportunity rules 304 may be made more specific when additional data is available for evaluation. For example, based upon the name of the theater near end location 204, show times may be determined automatically, and condition 402(1)(B) may specify “end time between 90 minutes and 30 minutes prior to the show start time”. Dynamic display server 102 then automatically retrieves the show start times for the current day to determine whether the condition is met. Similarly, when the baseball team associated with the baseball stadium near end location 204 is currently playing away, dynamic display server 102 may not identify the passenger 154 as a baseball fan when end location 204 is near the baseball stadium.

In one embodiment, where passenger 154 uses an app on their mobile device 156 to coordinate transport through transport network 140, the app may be configured to allow passenger 156 to enter additional profile information (e.g., age, gender, household income, and other demographic information). This additional profile information may be provided to dynamic display server 102 and used by display content matcher 108 to select content dynamically targeted display content 330 that is even more targeted to passenger 156. In one embodiment, a second app is installed on passenger mobile device 156 and launched automatically when passenger 156 interacts with transport network 140 to arrange transportation. For example, this second app may communication with the first app running on passenger mobile device 156 that communicates with transport network 140 to receive movement data 142, which together with additional profile information of passenger 156 (e.g., previously entered and stored within the second app) is sent to dynamic display server 102 to allow display content matcher 108 to select dynamically targeted content 330 based upon both movement data 142 and the additional profile information.

As shown in FIG. 3, content providers may specify, within display content requirement 122, one or more of display content 320, one or more display targets 322, one or more display areas 324, and a display period 326. Display content matcher 108 operates to match display content requirement 122 to one or more opportunities 107 within opportunity list 106 based upon at least one of display target 322, display area 324 and display period 326. For example, display content matcher 108 matches display areas 324 of display content requirement 122 to an opportunity area 312 of each opportunity 107 within opportunity list 106, and matches display target 322 to an opportunity target 310 of each already matched opportunity 107. Display period 326 may be used to specify the period when the associated display content should be displayed. For example, a content provider may only wish to display certain content during the hours of eight PM and ten PM, and would specify this within display period 326. Display content requirement 122 may include other information that determines when and how display content 320 may be displayed without departing from the scope hereof. In one embodiment, dynamic display server 102 may maintain a database of display content requirements 122 that are processed by display content matcher 108 to identify matching display content opportunities.

As opportunity finder 104 processes movement data 142, opportunity finder 104 may remove previously defined opportunities 107 from opportunity list 106 where the display content opportunity is determined to no longer exist. For example, when vehicle 150 reaches end location 204, the passenger 154 is assumed to disembark, and corresponding display content opportunity 107 is removed from opportunity list 106.

Opportunity rules 304 provide opportunity finder 104 with intelligence to recognize specific and dynamic opportunity targets 310 within transport network 140. This allows content providers to define, within display content requirement 122, one or more specific display targets 322 such that their display content 320 is delivered to more receptive targets (e.g., passengers of vehicles 150) and is thereby more successful.

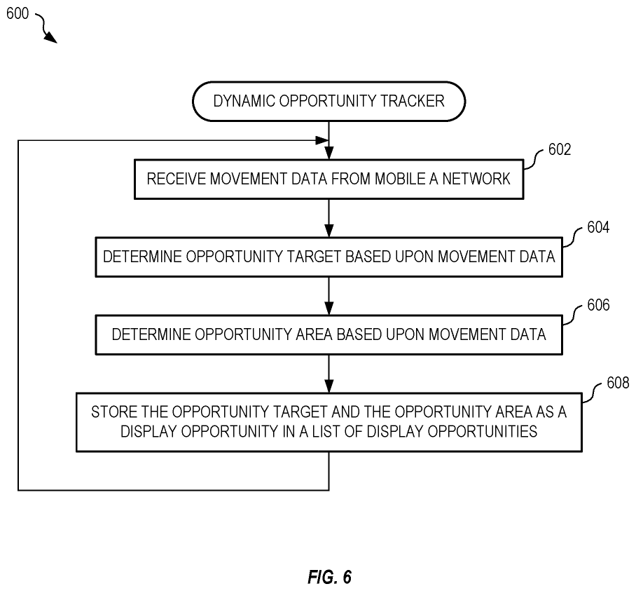

FIG. 6 is a flowchart illustrating one example method 600 for dynamically tracking display content opportunities. Method 600 is for example implemented in part within each of opportunity finder 104, display content matcher 108, and content deliverer 110 of dynamic display server 102.

In step 602, method 600 receives movement data from a mobile network. In one example of step 602, dynamic display server 102 receives movement data 142 from transport network 140. In step 604, method 600 determines an opportunity target based upon the movement data. In one example of step 604, opportunity finder 104 processes movement data 142 to identify at least one opportunity target 310 based upon location database 302 and opportunity rules 304. In step 606, method 600 determines an opportunity area based upon the movement data. In one example of step 606, opportunity finder 104 processes start location 202, end location 204, and route 208 of movement data 142 to identify at least one opportunity area 312. In one embodiment, opportunity finder 104 also determines an opportunity duration 314 based upon one or more of start location 202, end location 204, and route 208 of movement data 142. For example, duration 314 is the predicted duration of travel along route 208 by vehicle 150. When included, opportunity duration 314 may be used by display content matcher 108 to match display content requirement 122 to one or more display opportunities 107, where display content requirement 122 defines a minimum display time for display content 320, for example.

In step 608, method 600 stores the opportunity target and opportunity area as a display opportunity in a list of display opportunities. In one example of step 608, opportunity finder 104 generates and stores display opportunity 107, containing at least opportunity target 310 and opportunity area 312, within display opportunity list 106.

Steps 602 through 608 repeat for each received movement data 142 such that display opportunity list 106 dynamically changes based upon movement of vehicles 150 received from transport network 140.

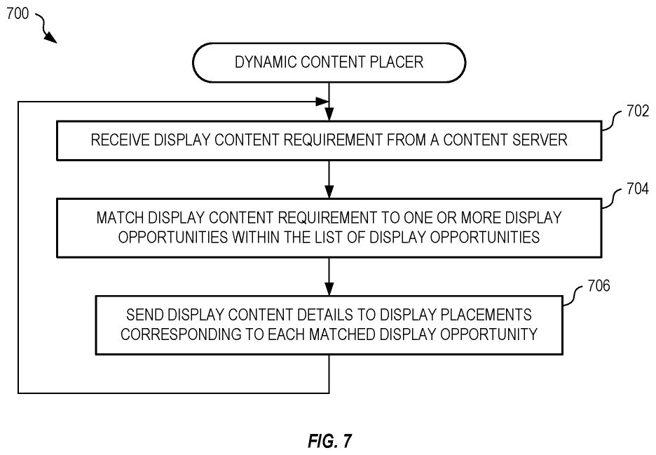

FIG. 7 shows one example method 700 for dynamically placing display content. Method 700 operates concurrently with method 600 of FIG. 6 within dynamic display server 102. For example, steps 702 and 704 are implemented within display content matcher 108 and step 706 is implemented within content deliverer 110.

In step 702, method 700 receives a display content requirement from a display content server. In one example of step 702, display content matcher 108 receives display content requirement 122 from content server 120. In step 704, method 700 matches the display content requirement to one or more display opportunities within the list of display content opportunities. In one example of step 704, display content matcher 108 compares display target 322 to opportunity target 310 and/or display area 324 to opportunity area 312 for each opportunity 107 within opportunity list 106 to identify matches.

In step 706, method 700 sends display content details to display placements corresponding to each matched display opportunity. In one example of step 706, content deliverer 110 sends display content 320 as dynamically targeted display content 330 to communication network 130 for delivery to mobile device 151 and non-networked display 152 in the corresponding vehicle(s) 150. In one embodiment, content deliverer 110 sends only instructions for display of an identified display content and/or product via communication network 130 to mobile device 151 in vehicles 150, where the display content and/or product has been previously delivered to vehicle 150. For example, based upon the identified display opportunity 107, a driver of vehicle 150 may be instructed to provide energy bar samples to a next passenger, since the next passenger is to be conveyed to an end location near a health club.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of providing dynamic, location-based content over a communications network to a non-networked digital display using a mobile device of a driver participating in a transport network, the method comprising:
connecting the non-networked digital display to the mobile device using a short-range wireless communication technology;
receiving, by the mobile device from the transport network, movement data corresponding to a transport request accepted by the driver, the movement data comprising a start location, start time, end location, and end time of the transport request;
sending the movement data over the communication network to a dynamic display server comprising a processor and memory storing a list of opportunity targets;
processing the movement data to generate a list of display opportunities;
comparing the list of display opportunities with display content requirements provided by content providers to identify display opportunities that match the movement data;
sending the display content over the communications network to the mobile device; and
sending the display content to the non-networked digital display over the short-range wireless communication technology.

2. The method of claim 1, wherein processing the movement data further comprises processing a location database and opportunity rules to determine opportunity targets.

3. The method of claim 2, determining opportunity targets comprises determining opportunity targets based upon a target rule that identifies the opportunity target using a condition corresponding to a location defined within the movement data.

4. The method of claim 1, further comprising receiving, from an app running on a mobile device of a passenger generating the transport request accepted by the driver, profile information of the passenger, and processing the movement data further comprises processing both the movement data and the profile information.

5. The method of claim 1, further comprising sending the display content to a mobile device of a passenger corresponding to the transport request.

6. The method of claim 1, wherein the display content further comprises a digital text message to the driver with instructions to perform an action.

7. The method of claim 1, wherein the display content requirements further comprise a display area matching the start location or end location of the movement data.

8. The method of claim 1, wherein the display content requirements further comprise a display period matching a start time or an end time of the movement data.

9. A computer-implemented method comprising instructions, stored on non-transitory computer-readable media, wherein the instructions, when executed by a computer, perform steps for providing dynamic, location-based content over a communications network to a non-networked digital display using a mobile device of a driver participating in a transport network, comprising:
connecting the non-networked display to the mobile device using a short-range wireless communication technology;
receiving, by the mobile device from the transport network, movement data corresponding to a transport request accepted by the driver, the movement data comprising a start location, start time, end location, and end time of the transport request;
sending the movement data over the communication network to a dynamic display server comprising a processor and memory storing a list of opportunity targets;
processing the movement data to generate a list of display opportunities;
comparing the list of display opportunities with display content requirements provided by content providers to identify display opportunities that match the movement data;
sending the display content over the communications network to the mobile device; and
sending the display content to the non-networked display over the short-range wireless communication technology.

10. The method of claim 9, wherein processing the movement data further comprises processing a location database and opportunity rules to determine opportunity targets.

11. The method of claim 10, determining opportunity targets comprises determining opportunity targets based upon a target rule that identifies the opportunity target using a condition corresponding to a location defined within the movement data.

12. The method of claim 9, further comprising receiving, from an app running on a mobile device of a passenger generating the transport request accepted by the driver, profile information of the passenger, and processing the movement data further comprises processing both the movement data and the profile information.

13. The method of claim 9, further comprising sending the display content to a mobile device of a passenger corresponding to the transport request.

14. The method of claim 9, wherein the display content further comprises a digital text message to the driver with instructions to perform an action.

15. The method of claim 9, wherein the display content requirements further comprise a display area matching the start location or end location of the movement data.

16. The method of claim 9, wherein the display content requirements further comprise a display period matching a start time or an end time of the movement data.
